(19) United States
(12) Patent Application Publication
(10) Pub. No.: US 2026/0115969 A1
(43) Pub. Date: Apr. 30, 2026

(54) SPLASHGUARD DEVICE FOR A WHEELED VEHICLE AND ASSEMBLY COMPRISING SUCH A DEVICE

(71) Applicant: SOPREMA, STRASBOURG (FR)

(72) Inventors: Pierre-Etienne BINDSCHEDLER, STRASBOURG (FR); Patrick BALL, BARR (FR)

(21) Appl. No.: 18/579,494

(22) PCT Filed: Jul. 8, 2022
(86) PCT No.: PCT/EP2022/069052

§ 371 Date: Jan. 15, 2024

(30) Foreign Application Priority Data
Jul. 16, 2021 (FR) FR2107679

(51) Int. Cl. B29B 7/72; B01F 27/091; B01F 27/1143; B01F 27/722; B01F 27/723; B01F 33/80; B01F 35/212; B01F 35/213; B01F 35/222; B01F 35/75; B01F 35/90; B01F 35/92; B01F 101/38; B29B 7/48; B29B 7/58; B29B 7/82; B29B 17/02; B29B 17/04; B29K 95/00; B29L 31/10; C10C 3/00

(52) U.S. Cl. CPC B29B 7/72; B01F 27/091; B01F 27/1143; B01F 27/722; B01F 27/723; B01F 33/83612; B01F 35/212; B01F 35/213; B01F 35/222; B01F 35/75471; B01F 35/92; B29B 7/48; B29B 7/582; B29B 7/826; B29B 17/02; B29B 17/04; C10C 3/002; C10C 3/007; B01F 2035/99; B01F 2101/38; B29B 2017/046; B29B 2017/0468; B29K 2095/00; B29L 2031/108

(57) ABSTRACT

The invention relates to a heatable mixer (1) for composite products based on thermoplastic material(s), having an elongate structure defining a longitudinal processing path between at least one inlet and at least one outlet (2′) and comprising a heated trough (3) in which two mutually interpenetrating parallel twin screws (4 and 4′) are mounted, forming member(s) for dimensionally reducing, heating and moving the products to be processed which are inserted at the inlet, each screw (4, 4′) comprising a heated and driven support shaft (5) arranged in the path direction (DT). The mixer (1) is characterised in that it comprises, at the or at each outlet (2′), a member (20) for controlling the liquid or semi-liquid output stream of processed products, flowing through the associated outlet (2′), advantageously under the effect of gravity.

The present invention concerns the field of recycling and upgrading of factory and site waste within the context of sealing materials and systems, in particular in relation with bituminous sealing membranes, and its subject is a heatable mixer with controlled outlet, an installation for treatment and upgrading of composite products based on thermoplastic materials, as well as a method for controlling such an installation.

Within the context of the general trend for seeking potential upgrading of waste, which is an increasing demand, and a problem which is currently not solved satisfactorily either at technical or economic level, involves factory waste, and above all site waste in the field of sealing, in particular in relation with bituminous sealing membranes.

One of the major problems which has been encountered, and has hitherto not been solved satisfactorily in the proposals according to the prior art, concerns the presence, which is often linked to the material to be upgraded (substantially the bituminous bonding agent), of pollutants which cannot be upgraded, in particular hard solid particles of the type such as metal, minerals or others (derived from assembly or securing elements, covering layers, surface protection layers, or the like).

In particular, dismantling waste from the refurbishment market has until now represented a significant potential source of sealing membranes to be treated, estimated at present at approximately 100,000 tonnes per year in France (estimation by the French Sealing Association), with this source being renewed each year. The cost of landfill for this waste has been increasing for many years, and this trend is liable to continue, especially since no real industrial solution for treatment of dismantling waste has been proposed hitherto.

There is therefore a strong and steady requirement to try to find an industrial solution to reduce the consumption of a fossil resource which is becoming rarefied, and which solution would be truly efficient in the recycling of sealing membranes.

However, the composition and therefore the treatment of this waste is complex, since when the roofs of buildings are repaired, it is possible, and common practice, to superimpose several layers of membranes on one another and to assemble them by gluing or welding, and to secure them mechanically on the support.

However, after a certain number of repairs (depending on the legislation of the country concerned in this respect), it is technically necessary and administratively compulsory to remove all of the covering system, and put new sealing into place on the roof (with a framework; flat roof or other structure) in the untreated form.

The waste recuperated upon completion of this total removal operation, known as dismantling waste, substantially comprises layers of bituminous membranes adhering to one another and having different types of finish, in particular granules of slate, sand, complex aluminum sheets (PET-alu). This waste can also contain solid pollutants, in particular insulation (PUR, XPS, mineral wool, wood fiber, etc.), metal parts (metal fasteners for membranes secured mechanically, saw blades for cutting the waste, etc.), and other miscellaneous debris associated with the supply of a dumpster for recuperation of waste on a building site (pebbles, stones, cans, etc.).

Thus, in relation with the above-described demand, the composite products which it would be desirable to be able to treat within the context of the field of application concerned by the invention substantially comprise:
mostly bituminous membranes containing a reinforcement, for example: non-woven polyester, PNT, or glass fiber, etc.), a bituminous bonding agent (for example: polymer and bitumen, additives, filler, etc.), surface finishing (for example: granules of slate, sand, complex aluminum sheets, etc.). Potentially these membranes are agglomerated in successive layers which are fused on one another by heating during the laying, and thus form plates (dimensions of the recuperated plates: ˜1 m×˜1 m×(1 to 20) cm). Alternatively, the products to be treated can comprise rolls of bituminous membranes obtained from production (second best) or production trimmings from such rolls. Alternatively, these membranes can be pre-crushed.
pollutant solids of various kinds: insulation (PUR, XPS, mineral wool, wood fibers, etc.), metal parts (metal fasteners for membranes which are secured mechanically, saw blades for cutting of waste, etc.), or assorted debris (sand, grit, pebbles, stones, cans, etc.).

Upon completion of at least a first phase of the treatment, the outgoing product (output) should comprise in particular smooth bonding agents based on bitumen, also incorporating polymers and particles or fragments of dispersed fibers, preferably with a size smaller than 100 μm.

In addition, whereas the input is at ambient temperature (typically between 0° C. and 30° C.), the output from this first treatment should, by means of adequate transformation of the input, be at least at the temperature of use of the bituminous and thermoplastic bonding agents, i.e. typically between 150° C. and 200° C.

A state of this type of the output facilitates its further treatment, in particular the extraction of the solid macroscopic pollutants, which have not been reduced or have been insufficiently reduced during this first treatment phase (such as pebbles, stones, grit, screws, bolts, rivets, nails, fragments of sheet metal, etc.), as well as its subsequent transfer and packaging in a form which can be upgraded and is advantageously reusable.

For this purpose, and taking into account the type of input to be transformed/upgraded and its condition at the inlet, the technical device which carries out said (at least) first treatment phase should perform, progressively and simultaneously, heating of the input until a temperature of softening/melting of the bituminous bonding agent is obtained (at least in the vicinity of the outlet), and shearing of the membranes (whether precut or not), so as to obtain separation of their armatures and their disintegration. This device should also permit the passage of the aforementioned hard macroscopic pollutants, without risk of blockage, and should preferably have a limited level of wear.

However, the apparatuses and installations known hitherto for recycling of the aforementioned type of products does not make it possible to fulfil the above requirement, or obtain the required result, at least not reliably and in the long term. Thus, the separators of ferromagnetic metal pollutants (by means of magnets) or non-ferromagnetic separators (by means of Foucault current) which target only one type of pollutant, do not transform the products output, or transform them insufficiently, and do not permit extraction of elements which are embedded, imbricated, or too firmly bonded with the materials to be upgraded.

Similarly, the systems which are based on separation as the result of differences of densities between components, of the type such as centrifugal systems, densimetric tables, decantation devices or the like, are either inefficient, or economically unviable.

Some known devices carry out satisfactorily some of the aforementioned functions expected for the first treatment phase, but not all of them.

Thus, treatment devices of the type such as kneaders with heated arms in the form of a “Z” perform good shearing, but provide poor heating (method carried out per batch/lot), and paddle mixers provide satisfactory heating of the products and withstand pollutants well, but carry out mediocre shearing.

In addition, the known systems (cf. in particular WO 2008/103035, US 2005/263625, EP 1 123 182 and WO 2009/090546) in the form of extruders or conveyors with a conventional helical screw, are for their part subject to blockage when a hard macroscopic particle is present (of the type such as screws, bolts), and undergo significant and rapid wear in the presence of hard microscopic particles (such as sand).

Finally, conveyors-mixers with a double Archimedes screw are also known, wherein the screws as well as the trough are heated: they provide good heating and good shearing, but are also subject to the aforementioned blockages and substantial wear during the treatment of the composite products/waste previously described.

The applicant has already developed a mixer which makes it possible to overcome at least most of the disadvantages of the aforementioned known mixers. This mixer has an elongate composition defining a longitudinal treatment path between at least one inlet and at least one outlet, and comprises a trough which is heated, and in which there is fitted at least one screw, and preferably two twin screws which are parallel and interpenetrate at their threads, forming a unit/units for treatment by dimensional reduction and heating, and displacement towards said for the products to be treated introduced at the or each inlet. Said or each screw comprises a support shaft which is heated, rotated around its axis, and provided with blades forming the thread of the screw concerned, the or each shaft being positioned in the trough by being arranged in the direction of the path, and the products being displaced during the treatment from the inlet(s) as far as the outlet(s) under the action of the screw(s). This mixer is described in patent application PCT WO 2021/213793 in the name of the applicant, and can form part of a treatment installation as disclosed in patent application PCT WO 2021/213792 also in the name of the applicant.

However, the inventors have found during tests that it could be advantageous, or even necessary in certain operating modes, to be able to control the quantity of product treated (output) leaving the mixer, preferably without making the construction of the mixer significantly more complex, while if possible being able to guarantee a flow under the effect of gravity alone, without using additional means, and providing a solution appropriate for the particular nature of the output.

In order to fulfil this demand, the subject of the invention is a heatable mixer for composite products based on thermoplastic material(s) of the aforementioned type, which is characterized in that the opening of the or each outlet is formed directly in the wall of the trough, in that said mixer comprises, at the or each outlet, a unit to control the flow of liquid or semi-liquid output of products treated, flowing through the associated outlet, in that the or each unit to control the flow of output consists of a flap valve or pivoting valve, in that said flap valve or pivoting valve consists of a portion of the wall of the trough which is swept by blades, this portion being able to be displaced, preferably continuously, between a closure position in which it closes the outlet concerned, and is incorporated in said wall as a component part thereof, preferably with continuous surface connection with the inner face of this wall, and a maximal opening position in which the corresponding outlet is substantially totally open.

The invention will be better understood thanks to the following description, which relates to a preferred embodiment, provided by way of non-limiting example, and explained with reference to the appended schematic drawings, in which:

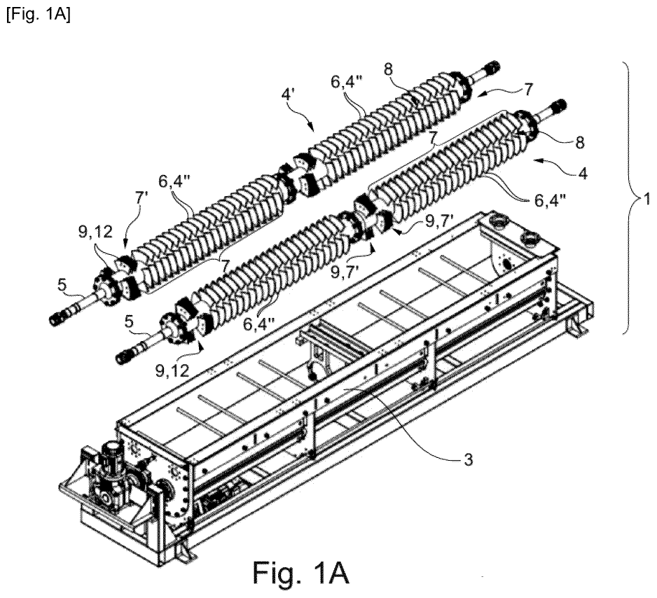

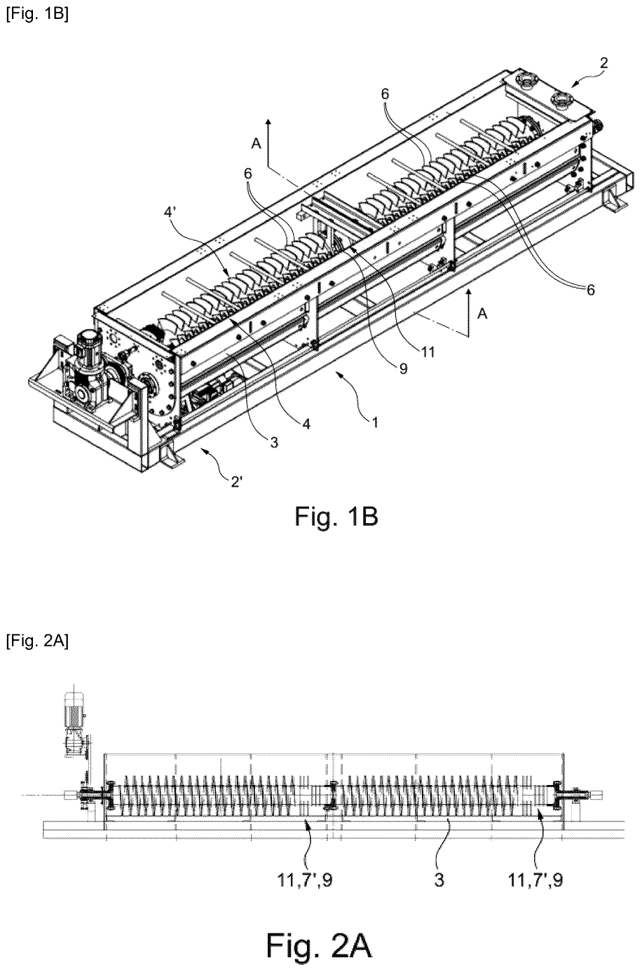

FIG. 1A is an exploded view of a heatable mixer of the type referred to within the context of the invention, but without a unit to control the outlet flow of product treated;

FIG. 1B is a view in perspective and from above of a heatable mixer according to FIG. 1A, with the closure cover of the trough removed;

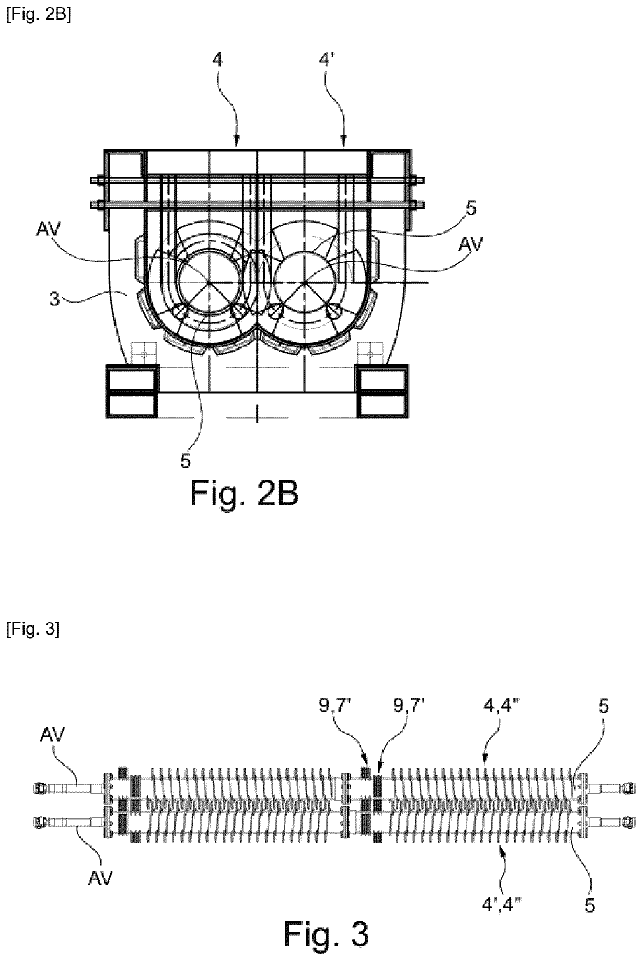

FIG. 2A is a view in cross-section along a vertical plane containing the longitudinal axis of the mixer of FIG. 1B;

FIG. 2B is an elevated view in the direction of the longitudinal axis, and partly in transparency, of the mixer represented in FIG. 1B;

FIG. 3 is a view from above of the two screws forming part of the mixer of FIGS. 1 and 2;

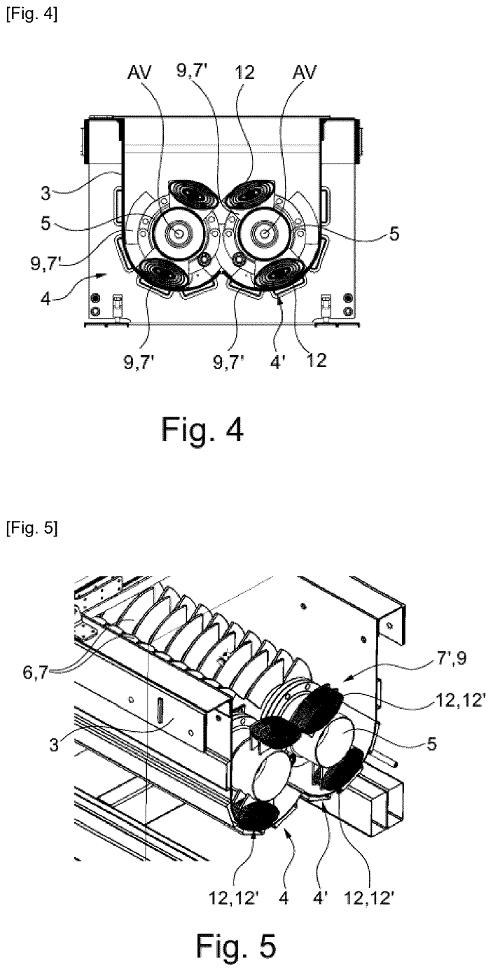

FIG. 4 is a view in cross-section along A-A, of the mixer of FIG. 1B;

FIG. 5 is a partial view and in perspective of the mixer of FIG. 4;

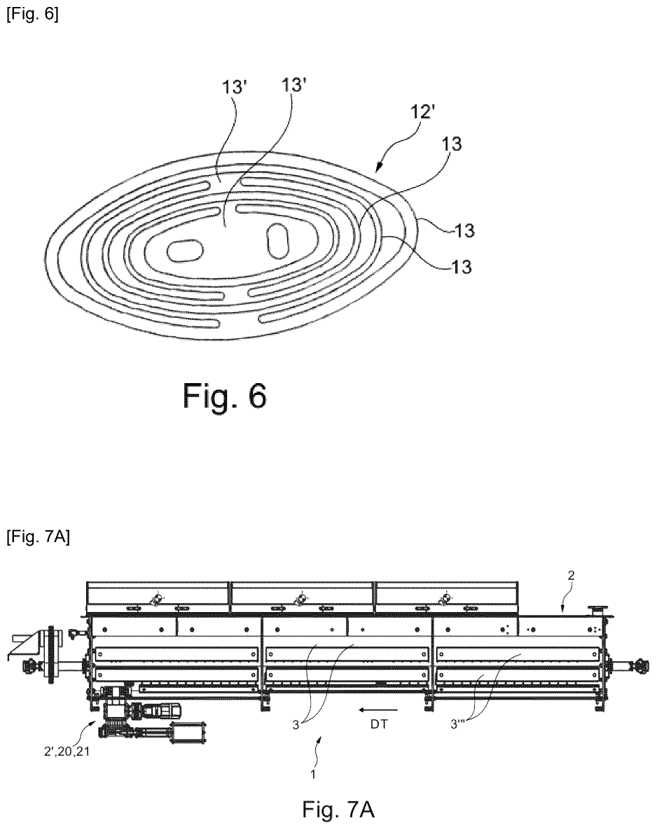

FIG. 6 is a detail view of a scraping structure forming part of the mixer represented in FIGS. 4 and 5;

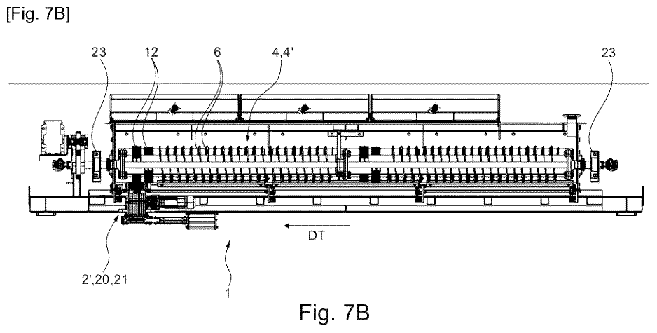

FIG. 7A AND

FIG. 7B are views in lateral elevation (7A) and in cross-section (7B) along a vertical plane which is offset relative to that of FIG. (7A), of a heatable mixer according to the invention;

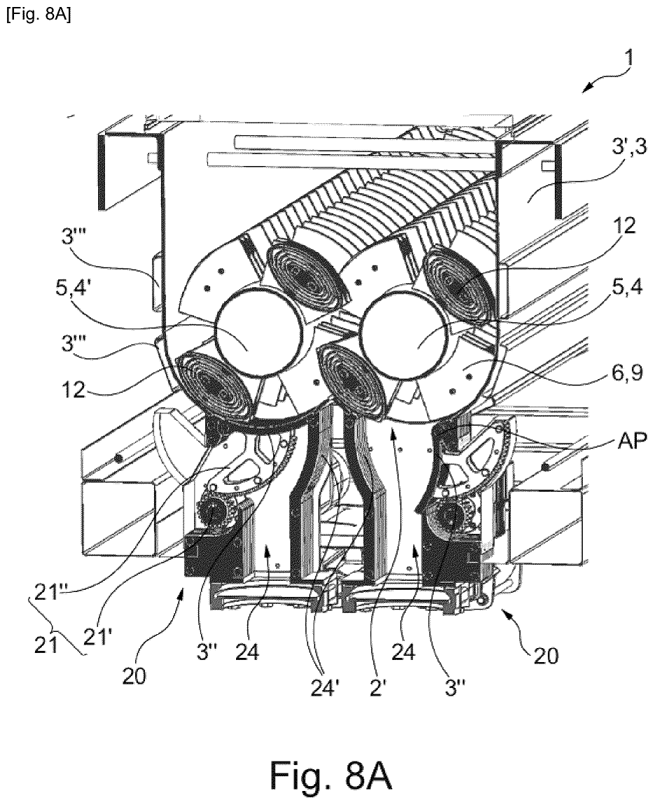

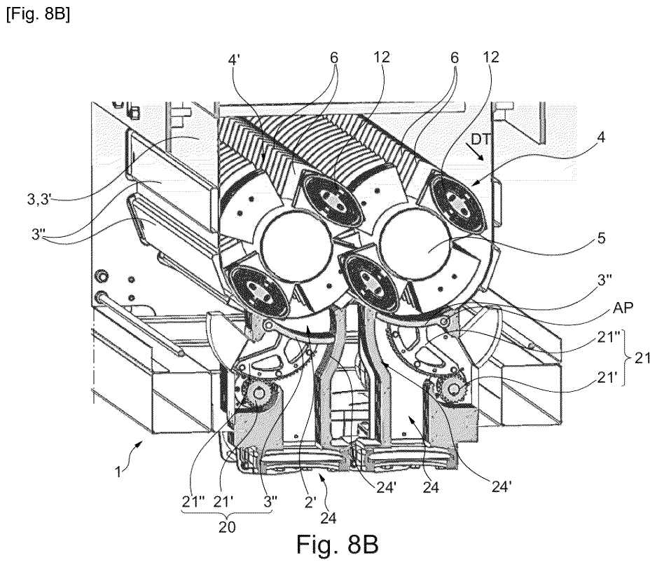

FIG. 8A and

FIG. 8B are partial views in cross-section and in perspective, at the outlets of the mixer of FIG. 7, in two different directions and with different degrees of opening of the outlets;

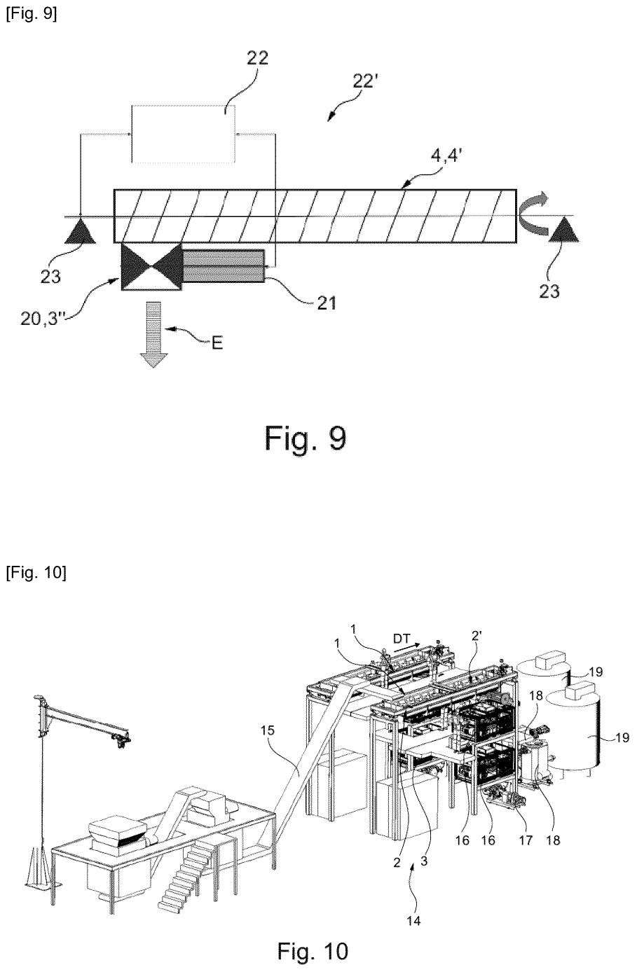

FIG. 9 is a schematic representation illustrating the control loop which controls the outlet flow of the mixer of FIGS. 7 and 8;

FIG. 10 is a view in perspective of an installation for treatment and upgrading comprising two mixers according to FIGS. 1 to 9, fitted in parallel, and forming the first treatment stations of this installation.

FIGS. 1 to 8 illustrate at least partly a heatable mixer 1 for composite products based on thermoplastic material(s), in particular factory or site waste containing mostly bituminous membranes.

Said mixer 1 has an elongate composition defining a longitudinal treatment path between at least one inlet 2 and at least one outlet 2′, and comprising a trough 3 which is heated, and in which there is fitted at least one screw 4, 4′, preferably two parallel twin screws 4 and 4′ which interpenetrate at their threads 4″ forming a treatment unit/treatment units by dimensional reduction and heating and displacement towards said outlet(s) 2′ for the products to be treated introduced at the inlet 2 or each inlet 2. Said or each screw 4, 4′ comprises a support shaft 5 which is heated, is rotated around its axis, and is provided with blades 9, 9′ forming the thread 4″ of the screw 4, 4′ concerned, the or each shaft 5 being positioned in the trough 3 by being arranged in the direction of the path DT, and the products being displaced during treatment from the inlet(s) 2 as far as the outlet(s) 2′ under the action of the screw(s) 4, 4′.

The trough 3 and the shaft 5 can be heated by a liquid fluid, or can comprise added-on heating means, which in particular are electrical. The or each outlet is preferably situated in a lower region of the trough 3, in which the output can be conveyed by the action of displacement of the screw(s) 4, 4′.

According to the invention, and as shown in FIGS. 7 to 9, this mixer 1 is characterized in that the opening of the or each outlet 2′ is formed directly in the wall 3′ of the trough 3, in that said mixer 1 comprises, at the or each outlet 2′, a unit 20 to control the flow of liquid or semi-liquid output of products treated, flowing through the associated outlet 2′, in that the or each unit 20 to control the flow of output consists of a flap valve or pivoting valve, in that said flap valve or pivoting valve consist of a portion 3″ of the wall 3′ of the trough 3 which is swept by blades 9, 9′, this portion 3″ being able to be displaced, preferably continuously, between a closure position, in which it closes the outlet 2′ concerned, and is incorporated in said wall 3′ as a component part thereof, preferably with continuous surface connection with the inner face of this wall, and a maximal opening position, in which the corresponding outlet 2′ is substantially totally open.

Thanks to these arrangements, the invention fulfils the demand previously expressed, by providing a simple and high-performance solution to it, which is suitable for the nature of the output, and is substantially in accordance with the preferred requirements also expressed above. Since the region of the trough 3 which has the outlet(s) 2′ is swept by the screw or at least one of the screws, any accumulation of output in this region is prevented when the corresponding valve 20 is in the closed state. This prevents the formation of a vault or thickness of output which could hold back, or even block, the flow of output at the opening of the valve concerned.

According to the invention, the or each unit 20 proposed is thus of the type with a progressive passage opening, and can be controlled independently, either for a supply of output continuously (the output of material discharged thus being determined directly and only by the degree of opening), or for a supply of output sequentially or in successive batches (opening by intermittence, with the output being determined both by the degree of opening and the length of the opening time).

When the mixer 1 has two openings 2′ and two units 20, they can be controlled either separately and independently, or in common and synchronously, or also in one manner or the other depending on the requirements of the operator or the needs of the global treatment process.

Advantageously, the trough 3 comprises a wall 3′ with a double envelope, and the shaft 5 is a hollow tube, with both having a hot liquid (oil) passing through them. As a variant, the wall 3′ can also be a simple skin, and comprise channels 3″ for circulation of hot fluid on the exterior. The or each flap valve 3″ advantageously has a single-wall structure (for example metal plate with a curved form), which is optionally thermally insulated.

As shown in FIGS. 4, 5 and 8 in particular, the wall 3′ of the trough 3 has, in the lower part forming the base of the trough, a curved (partly cylindrical) shape which matches the form of the or each screw 4, 4′ over a part of its or their circumference. It is in this or these base region(s) of the wall 3′ that the outlet(s) 2′is/are preferably located, the or each flap valve having a form which is integrated continuously in the corresponding base region.

According to a possible practical construction of the invention, which is illustrated in FIG. 8, and combines simplicity, robustness and precision of control, the or each pivoting flap valve 20 comprises, in addition to the flap valve 3″ which forms a movable portion of the wall 3′ of the trough 3, an actuator in the form of a motorized device 21 with a rack, which determines the positioning in pivoting of the flap valve 3″ concerned, and thus the state of opening/closure of the corresponding outlet. This motorized device 21 is advantageously in the form of a driven pinion 21′ which engages with a rack 21″ in the form of an arc of a circle integral with said flap valve 3″, preferably supporting the valve. The position of the or each flap valve 3″ can be determined very precisely by a position encoder or by a sensor (at the axis of pivoting of the flap valve 3″ or the motorized pinion 21′).

According to a simple practical construction illustrated in FIG. 8. It can be possible, in a combined manner, for the opening of the or each outlet 2′ to be formed in a curved portion of the wall 3′ of the trough 3, for the flap valve 3″ concerned, which constitutes a movable portion of said wall 3′ which can be, and is designed to, close this opening in a sealed manner against the output, to have an inner face having a curved surface with a radius identical to that of the surrounding curved region of the inner face of the wall 3′ around the outlet opening concerned, and for the axis AP of connection with pivoting of said flap valve 3″ with said wall 3′ to be parallel to the axis of rotation of the or each shaft 5.

According to a characteristic of the invention, shown in FIG. 9, where each unit or valve 20 to control the flow of output E flowing through the associated outlet 2′ is controlled by an automatic control device 22 associated with, or incorporated in, a system to control the operation of the mixer 1, if applicable in relation with a program to control the operating mode of said mixer 1, this device 22 evaluating at least signals which are indicative of the quantity of products present in this mixer 1, and controlling the position or state of the unit 20 accordingly, for example by means of the aforementioned motorized device 21 with a rack.

Preferably, and as shown symbolically in FIG. 9 and partly in FIG. 7, the automatic control device 22 forms part of a loop 22′ to control the flow of output from said mixer 1. The signals which indicate the quantity of products present in the mixer 1 can be provided by at least one weighing means 23 of said mixer 1, for example a pair of weighing cells. The loop 22′ itself can form part of, or be dependent on, a control system of a treatment installation 14 in which said mixer 1 is incorporated.

As shown in FIG. 8, and for the purpose for example of being able to direct the flow of output towards a consecutive treatment station (while avoiding dispersions), at the or each outlet 2′ and in the extension to the exterior of the opening thereof, in the form of a rectangular opening in the wall of the trough 3, the trough 3 can comprise a joining piece 24 forming a discharge channel. This joining piece 24 also advantageously provides a preferential flow surface 24′ for the output, adjoining the opening of the outlet 2′ concerned, and with which the flap valve 3″ cooperates during its opening movement in order to define a discharge passage with a variable cross-section.

According to a preferred practical construction, which assists precise progressive opening of the outlet 2′ concerned, the free end of the pivoting flap valve 3″ sweeps the preferential flow surface 24′ over a part of its pivoting movement, at least at the start of the clearing of the opening of the outlet 2′, said flap valve 3″ advantageously constituting part of the discharge channel 24 in its maximal opening position. A configuration of this type of the flap valve 3″ and of the surface 24′ permits in particular self-regulation of the flow of output E for a given viscosity.

Although not represented, the heatable mixer 1 according to the invention can comprise only a single screw, and thus a single outlet and a single unit to control the output flow.

However, preferably, and as shown in the appended figures, the mixer according to the invention comprises two parallel twin screws 4 and 4′, each screw 4, 4′ being associated with a respective outlet 2′ provided with a corresponding unit 20 to control the output flow discharged through the outlet 2′ concerned.

As shown in FIGS. 1 to 3 and 7B, the thread 4″ of the or each screw 4, 4′ is an interrupted or discontinuous thread, and comprises, over at least most of the length of the screw 4, 4′ concerned, a plurality of first blades 6 in the form of smooth flat plates, separated from one another axially and radially, and all arranged according to a constant screw pitch, and with a determined inclination relative to a plane perpendicular to the axis AV of the screw 4, 4′ concerned.

The helical thread 4″ of each of the two screws 4 and 4′, which rotate in directions of rotation contrary to one another, such as to generate a movement of transport of material from the inlet 2 to the outlet 2′ of the trough 3 (in the direction DT), is thus constituted by a plurality of blades 6 in the form of distinct and separate flat sectors of a ring, which are rendered integral (by welding for example) with the shaft 5 of the screw 4, 4′ concerned along a helical line. In addition, these blades 6 are arranged with mutual spacing, and individual angular extension, such that longitudinal alignments 7 of blades 6 are constituted.

Preferably, each first blade 6 has an angular extension around the shaft concerned which is smaller than 180°, advantageously smaller than 120°, and preferably approximately 90°. In addition, said first blades 6 are configured and arranged on the support shaft 5 concerned such as to constitute a limited number of alignments 7 of blades 6 in the direction of the axis AV of the screw 4, 4′, which are distributed on the periphery of the support shaft 5, and define between one another clear areas 8 extending along the screw 4, 4′ between adjacent alignments 7.

Thus, each of the screws 4, 4′ is substantially, at least along part of its length, like an Archimedes screw with a continuous helical thread, but cut in the direction of the axis AV of the shaft 5 in order to form straight gaps parallel to said axis AV.

It is the spaces between the blades 6, and more particularly the passages in the form of resulting gaps, which permit the transport without blockage of the macroscopic pollutants (present in the products to be treated forming inputs) from the inlet 2 towards outlet 2′.

In addition, the metal blades 6 are relatively thick (for example 8 to 15 mm) such as to guarantee a certain thermal inertia in order to heat the bitumen in the mass, while seizing and “breaking up” the inputs in the form of membranes. (Effect of “insertion of a hot knife into cold butter”). In addition, since they are flat and smooth, the blades 6 do not allow the bituminous bonding agent or the like to catch on them.

According to a preferred variant embodiment, illustrated in FIGS. 1, 2, 4, 5 and 7B, the or each screw 4, 4′ comprises on at least part of its length a plurality of second blades 9 in the form of flat plates, which are separated from one another, and are all arranged on planes perpendicular to the axis of the screw 4, 4′ concerned, each second blade 9 has an angular extension smaller than 180°, advantageously smaller than 120°, preferably approximately 90°, and said second blades 9 are configured and arranged on the support shaft 5 concerned such as to constitute a limited number of alignments 7′ of blades in the direction of the axis AV of the screw 4, 4′ and around the shaft 5, with cleared areas extending between the adjacent alignments 7′ (angularly or circumferentially) along the screw 4, 4′.

Whereas the first blades 6 are fitted on the respective shaft 5 with inclination relative to a plane perpendicular to the axis AV of said shaft, the second blades 9 for their part are fitted perpendicularly to this axis AV.

Advantageously, each alignment 7′ of second blades 9 extends over only a fraction of the length of the part of the screw 4, 4′ which comprises them, and over a fraction of the periphery of the shaft 5 thereof, and constitutes at least one local set of second blades 9, with each set being offset angularly and/or axially relative to each of the other sets, and at least one, and preferably each, set of second blades 9 of a screw 4, 4′ is engaged interpenetrating, in an interstitial manner, with a corresponding set of second blades 9 of the other screw 4′, 4.

In addition or alternatively, on part at least of its inner face, situated facing the longitudinal part(s) of the screw 4, 4′ comprising second blades 9, the trough 3 can comprise fixed counter-blades, situated on planes which are parallel and interstitial relative to the planes of the second blades 9, and which engage in an interpenetrating manner with the second blades 9 during the rotation of the screw 4, 4′ concerned, with each cooperating arrangement of at least two sets of movable second blades 9 belonging respectively to one of the two screws 4, 4′, and, optionally, fixed counter-blades, constituting a preferential shearing module 11.

Thus, the second blades 9 of the screws 4, 4′ do not only interfere and interpenetrate between the two screws 4 and 4′, but also with fixed counter-blades which are installed in the trough 3, for example on a support structure which is fitted in an interchangeable manner in the trough 3 (not represented).

The areas of the mixer 1 comprising sets of pluralities of movable second blades 9, and optionally fixed counter-blades, constitute intense shearing modules, as a result of the density of elements forming interpenetrating blades with small air gaps. The mixer 1 can comprise one or a plurality of such modules, if applicable distributed along the trough 3. Preferably, a (final) shearing module is arranged in the vicinity of the outlet of the mixer 1.

The provision of distribution of the second blades 9 in the form of alignments 7′ which are spaced circumferentially and/or axially allows the solid macroscopic pollutants to pass through the areas of these modules without blocking the screws 4, 4′.

As shown by way of illustrative example in FIGS. 2A, 3 and 7B, the or each screw is advantageously constituted by differentiated longitudinal segments comprising alternately alignments of first inclined blades 6 and alignments of second perpendicular blades 9.

In order to limit the wear of the first and/or second blades 6, 9 (by providing a sufficient air gap between their outer edges and the wall of the trough 3), while assisting firstly the thermal transfer between the screws 4, 4′ and/or the trough 3 and the products to be treated in transit, and, secondly, the shearing (despite the presence of a significant air gap—for example 0.5 mm to 3 to 5 cm—between the blades 6, 9 and the trough 3), at least some first and/or second blades 6, 9 can be provided, at their outer free edge 9′, with at least one added-on scraping structure 12, which projects radially relative to said edge 9′, and is resiliently deformable at least in a radial direction, with this scraping structure or these scraping structures 12 sweeping, advantageously with sliding support under resilient pressure, at least part of the inner face of the wall 3′ of the trough 3 (see FIGS. 4 to 6 and 8).

As shown in FIG. 8, at least one scraping structure 12 (and preferably a plurality of them fitted on the ends of the blades 6, 9 of the screws) is present at the or each portion 3″ of the wall 3′ of the trough 3 forming a flap valve, with the inner surface of this portion 3″ being swept by this structure at each rotation of the screw 4, 4′concerned. Thus, the flap valves 3″ are guaranteed to be free from any accumulation of material which could block their operation, and this makes it possible to keep the inner face of the wall 3′ clean and free from any agglomeration of components of the output (fibers, minerals, bitumen, etc.), which could impede the flow of output at the opening (in particular during partial opening) and/or the handling of the flap valve.

According to a preferred embodiment, shown in the aforementioned FIGS. 4 to 6 and 8, the or each deformable added-on structure 12 consists of a small plate 12′, or of a stack of at least two small plates 12′, with a contour with a substantially elliptical form, and comprising cut-outs defining a plurality of concentric elliptical rings 13, connected by bridges of material 13′ between adjacent rings 13, said structure 12 being fitted on the corresponding blade 6, 9 with an orientation such that the direction of the small half-axis of the elliptical contour passes via the longitudinal axis AV of the support shaft 5.

Said mixer 1 advantageously comprises two parallel twin screws 4 and 4′, the respective blades 6, 9 of which interweave closely on at least part of their height, preferably on most of it, either in at least an area of mutual engagement of the opposing threads of first blades 6 which are inclined relative to the axis of the support shaft 5, or in at least one area of mutual interpenetration of second blades 9 perpendicular to the axis of the support shaft 5, advantageously in both types of areas.

As shown for example in FIG. 10, the subject of the invention is also an installation 14 for treatment and upgrading of composite products based on thermoplastic, for example waste which includes mostly bituminous products, in particular bituminous membranes, which if applicable are precut or fragmented.

This installation 14 is characterized in that it comprises as a treatment station/treatment stations at least one mixer 1 as previously described, preferably as the first treatment station.

As represented in FIG. 10, the installation 14 can comprise two heatable mixers 1 as described above, fitted in parallel, supplied with inputs by a conveyor belt 15 (transporting pre-cut waste for example), and each forming the first station of a treatment and upgrading line, respectively associated downstream.

This installation comprises for example two heatable mixers 1 fitted in parallel, supplied with inputs by a conveyor belt 15, and each forming the first station of a treatment and upgrading line, respectively associated downstream. These mixers 1 are installed at a height such that their liquid or semi-liquid outputs, discharged by the openings of the outlets 2′, fall through two superimposed crushing stations 16, each formed by a crusher with opposing rollers, and the air gaps of which are aligned. Between the two crushing stations 16, a solid macroscopic pollutants separator device is arranged, in the form of a discharge device, with a unit for movable extraction, for example by pivoting, not shown in FIG. 10.

Then, the output from which macroscopic pollutants have been eliminated can be transferred (for example by means of a comminutor pump 17), into a refiner 18 with a drum which is fitted such as to be movable eccentrically in a cylindrical enclosure, in order then to be stored in a tank 19 in the form of reusable upgraded product.

An installation of this type is described and represented in the patent application previously referred to in the introduction.

The subject of the invention is also a method for controlling a mixer 1 as previously described, characterized in that it consists, either in a continuous operation mode, or in a mode of sequential operation in batches, of driving the screw(s) 4, 4′ with a control protocol comprising at least two driving phases giving rise to displacement of the materials in the mixer 1 in the direction DT of the treatment path, separated by at least one opposing driving phase, i.e. giving rise to displacement of the treated materials in the direction opposite the treatment path, with the occurrence, duration and number of the opposing driving phases being either predetermined, or dependent on values provided by sensors for measurement of operating parameters, such as, for example, the driving torque, the composition and/or the quality of the products treated, and the quantity of materials present in the mixer 1.

It will be appreciated that the invention is not limited to the embodiment described and represented in the appended drawings. Modifications remain possible, in particular from the point of view of the composition of the various elements, or by substitution of technical equivalents, without however departing from the field of protection of the invention.

1. A heatable mixer (1) for the treatment of composite products based on thermoplastic material(s), in particular factory or site waste containing mostly bituminous membranes, said mixer (1) having an elongate composition defining a longitudinal treatment path between at least one inlet (2) and at least one outlet (2′), and comprising a trough (3) which is heated, and in which there is fitted at least one screw (4, 4′), and preferably two twin screws (4 and 4′) which are parallel and interpenetrate at their threads (4″), forming a unit/units for treatment by dimensional reduction and heating, and displacement towards said outlet(s) (2′) for the products to be treated introduced at the (2) or each (2) inlet, said or each screw (4, 4″) comprising a support shaft (5) which is heated, and rotated around its axis, the or each shaft (5) being positioned in the trough (3) by being arranged in the direction of the path (DT), and the products being displaced during the treatment from the inlet(s) (2) as far as the outlet(s) (2′) under the action of the screw(s) (4, 4′), and said mixer (1) comprising, at the or each outlet (2′), a unit (20) to control the flow of liquid or semi-liquid output of products treated, flowing through the associated outlet (2′),
heating mixer (1) characterized in that the support shaft (5) is provided with blades (9, 9′ forming the thread (4″) of the screw (4, 4′) concerned, in that the opening of the or each outlet (2′) is formed directly in the wall (3′) of the trough (3), in that the or each unit (20) to control the flow of output consists of a flap valve or pivoting valve, and in that said flap valve or pivoting valve consists of a portion (3″) of the wall (3′) of the trough (3) which is swept by blades (9, 9′), this portion (3″) being able to be displaced, preferably continuously, between i) a closure position in which it closes the outlet (2′) concerned, and is incorporated in said wall (3′) as a component part thereof, preferably with continuous surface connection with the inner face of this wall, and ii) a maximal opening position in which the corresponding outlet (2′) is substantially totally open.

2. The heatable mixer as claimed in claim 1, characterized in that the or each pivoting flap valve (20) comprises, in addition to the flap valve (3″) which forms a movable portion of the wall (3′) of the trough (3), an actuator in the form of a motorized device (21) with a rack, which determines the positioning in pivoting of the flap valve (3″) concerned, and thus the state of opening/closure of the corresponding outlet (2′), this device (21) advantageously being in the form of a driven pinion (21′) which engages with a rack (21″) in the form of an arc of a circle integral with said flap valve (3″).

3. The heatable mixer as claimed in either of claims 1 and 2, characterized in that the opening of the or each outlet (2′) is formed in a curved portion of the wall (3′) of the trough (3), in that the flap valve (3″) concerned, which constitutes a movable portion of said wall (3′) which can, and is designed to, close this opening in a sealed manner against the output, has an inner face having a curved surface with a radius identical to that of the surrounding curved region of the inner face of the wall (3′) around the outlet opening concerned, and in that the axis (AP) of connection with pivoting of said flap valve (3″) with said wall (3′) is parallel to the axis of rotation of the or each shaft (5).

4. The heatable mixer as claimed in any one of claims 1 to 3, characterized in that the or each pivoting flap valve (20) is controlled by an automatic control device (22) associated with, or incorporated in, a system to control the operation of the mixer (1), if applicable in relation with a program to control the operating mode of said mixer (1), this device (22) evaluating at least signals which are indicative of the quantity of products present in this mixer (1), and controlling the position or state of the unit (20) accordingly, for example by means of the aforementioned motorized device (21) with a rack, thus determining the positioning in pivoting of the flap valve (3″) concerned.

5. The heatable mixer as claimed in claim 4, characterized in that the automatic control device (22) forms part of a loop to control the flow of output from said mixer (1), and in that the signals which indicate the quantity of products present in the mixer (1) are provided by at least one weighing means (23) of said mixer (1), for example a pair of weighing cells.

6. The heatable mixer as claimed in any one of claims 2 to 5, characterized in that, at the or each outlet (2′) and in the extension to the exterior of the opening thereof, in the form of a rectangular opening in the wall (3′) of the trough (3), the trough (3) comprises a joining piece (24) forming a discharge channel, this joining piece (24) providing a preferential flow surface (24′) for the output, adjoining the opening of the outlet (2′) concerned, and with which the flap valve (3″) cooperates during its opening movement in order to define a discharge passage with a variable cross-section.

7. The heatable mixer as claimed in claim 6, characterized in that the free end of the pivoting flap valve (3″) sweeps the preferential flow surface (24′) over a part of its pivoting movement, at least at the start of the clearing of the opening of the outlet (2′), said flap valve (3″) advantageously constituting part of the discharge channel (24) in its maximal opening position.

8. The heatable mixer as claimed in any one of claims 1 to 7, characterized in that the thread (4″) of the or each screw (4, 4′) is an interrupted or discontinuous thread, and comprises, over at least most of the length of the screw (4, 4′) concerned, a plurality of first blades (6) in the form of smooth flat plates, separated from one another axially and radially, and all arranged according to a constant screw pitch, and with a determined inclination relative to a plane perpendicular to the axis (AV) of the screw (4, 4′) concerned, and in that the or each screw (4, 4′) comprises, on at least part of its length, a plurality of second blades (9) in the form of flat plates, which are separated from one another, and are all arranged on planes perpendicular to the axis of the screw (4, 4′) concerned, and in that said second blades (9) are configured and arranged on the support shaft (5) concerned such as to constitute a limited number of alignments (7′) of blades in the direction of the axis (AV) of the screw (4, 4′) and around the shaft (5), with cleared areas extending between the adjacent alignments (7′) along the screw (4, 4′).

9. The mixer as claimed in any one of claims 1 to 8, characterized in that at least some first and/or second blades (6, 9) are provided, at their outer free edge (9′), with at least one added-on scraping structure (12), which projects radially relative to said edge (9′), and is resiliently deformable at least in a radial direction, with this scraping structure or these scraping structures (12) sweeping, advantageously with sliding support under resilient pressure, at least part of the inner face of the wall (3′) of the trough (3).

10. The mixer as claimed in claims 2 and 9, characterized in that at least one scraping structure (12) is present at the or each portion (3″) of the wall (3′) of the trough (3) forming a flap valve, with the inner surface of this portion (3″) being swept by this structure at each rotation of the screw (4, 4′) concerned.

11. The mixer as claimed in any one of claims 1 to 10, characterized in that it comprises two parallel twin screws (4 and 4′), the respective blades (6, 9) of which interweave closely on at least part of their height, preferably on most of it, either in at least an area of mutual engagement of the opposing threads of first blades (6) which are inclined relative to the axis of the support shaft (5), or in at least one area of mutual interpenetration of second blades (9) perpendicular to the axis of the support shaft (5), advantageously in both types of areas, each screw (4, 4′) being associated with a respective outlet (2′) provided with a corresponding unit (20) to control the output flow discharged through the outlet (2′) concerned.

12. An installation (14) for treatment and upgrading of composite products based on thermoplastic, for example waste which includes mostly bituminous products, in particular bituminous membranes which if applicable are precut or fragmented, characterized in that it comprises as a treatment station/treatment stations at least one mixer (1) as claimed in any one of claims 1 to 11, preferably as the first treatment station.

13. The installation for treatment and upgrading as claimed in claim 12, characterized in that it comprises two heatable mixers (1), fitted in parallel, supplied with inputs by a conveyor belt (15), and each forming the first station of a treatment and upgrading line, respectively associated downstream, in that these mixers (1) are installed at a height such that their liquid or semi-liquid outputs, discharged by the openings of the outlets (2′), fall through two superimposed crushing stations (16), each formed by a crusher with opposing rollers, and the air gaps of which are aligned, and in that, between the two crushing stations (16), a solid macroscopic pollutants separator device is arranged, in the form of a discharge device, with a unit for movable extraction, for example by pivoting.

14. A method for controlling a mixer (1) as claimed in any one of claims 1 to 12, characterized in that it consists, either in a continuous operation mode, or in a mode of sequential operation in batches, of driving the screw(s) (4, 4′) with a control protocol comprising at least two driving phases giving rise to displacement of the materials in the mixer (1) in the direction (DT) of the treatment path, separated by at least one opposing driving phase, i.e. giving rise to displacement of the treated materials in the direction opposite the treatment path, with the occurrence, duration and number of the opposing driving phases being either predetermined, or dependent on values provided by sensors for measurement of operating parameters, such as, for example, the driving torque, the composition and/or the quality of the products treated, and the quantity of materials present in the mixer (1).
